(19) United States
(12) Patent Application Publication
(10) Pub. No.: US 2007/0100602 A1
(43) Pub. Date: May 3, 2007

(54) Method of generating an exceptional pronunciation dictionary for automatic korean pronunciation generator

(76) Inventor: Sunhee Kim, Seoul (KR)

Correspondence Address: MARGER JOHNSON & MCCOLLOM, P.C., 210 SW MORRISON STREET, SUITE 400, PORTLAND, OR, 97204, US

(21) Appl. No.: 10/561,633

(22) PCT Filed: Jun. 17, 2003
(86) PCT No.: PCT/KR03/01187

§ 371 Date: Dec. 19, 2005

(51) Int. Cl. G06F 17/20

(52) U.S. Cl. 704/8

(57) ABSTRACT

Disclosed is a method of creating an exceptional pronunciation dictionary for automatic pronunciation generation in Korean. The automatic pronunciation generator in Korean is an essential element of a Korean speech recognition system and a TTS (Text-To-Speech) system. The automatic pronunciation generator in Korean is comprised of a part of regular rules and an exceptional pronunciation dictionary. The exceptional pronunciation dictionary is created by extracting the words which have exceptional pronunciations from text corpus based on the characteristics of the words of exceptional pronunciations through phonological research and text analysis. Thus, the method contributes to the performance improvement of automatic pronunciation generator in Korean as well as that of a speech recognition system and a TTS system in Korean.

### TECHNICAL FIELD

The present invention relates to a method of generating an exceptional pronunciation dictionary for automatic Korean pronunciation generator in a Text-to-Speech system or in an automatic speech recognition system.

### BACKGROUND OF INVENTION

Conventionally, a method for automatic Korean pronunciation generator as shown in FIG. 1 comprises the steps of analyzing and pre-processing inputted text; analyzing morphemes of the text; tagging POS (part of speech); and generating pronunciations based on an exceptional pronunciation dictionary and a part of regular rules for changing phonemes. The automatic Korean pronunciation generator is characterized by two parts: the dictionary of exceptional words and the part of regular rules for changing phonemes. The exceptional words have been recorded in the dictionary for exceptional words in a simple and random manner, whereas the researches on the regular rules for changing phonemes have been actively progressed.

One example of regular rules is the Fortition of lenis consonantⁱ, e.g., a Korean word [symbol] is pronounced as [symbol] Thus, it is the Fortition rule that the Korean letter [symbol] after [symbol] is pronounced as [symbol] The Fortition rule actually includes that [symbol] as well as [symbol] after [symbol] are respectively pronounced as [symbol] When a Korean obstruent letter, [symbol] of a Korean word is positioned after another Korean obstruent letter, the [symbol] are respectively pronounced as [symbol] This Fortition Rule has no exceptions in a given environment.

On the contrary, alternative pronunciations can be observed in a certain context, in which the choice of the pronunciation depends on the words (idiosyncratic). And it is impossible to make rules for these words, which should be classified as words for the Exceptional Pronunciation Dictionary in TTS or ASR. For example, [symbol] and [symbol] are respectively realized as [symbol] and [symbol] In [symbol] a letter [symbol] located after a letter [symbol] is pronounced as [symbol] while in [symbol] a letter [symbol] located after a letter [symbol] is pronounced as [symbol] The Fortition in [symbol] is an exceptional case, which is not predictable, and needs to be recorded as an entry of the Exceptional Pronunciation Dictionary.

A generating process of the exceptional pronunciations in Korean has been known as a challenging task to be solved in the TTS system and the speech recognition system in Korean, but very little research has been conducted on this matter, for which, the characteristics of words having the exceptional pronunciations need to be dealt with in advance.

### DISCLOSURE OF INVENTION

Therefore, it is an object of the present invention to provide a method for generating an exceptional pronunciation dictionary for automatic Korean pronunciation generator by reviewing the words which have exceptional pronunciations from text corpus based on the characteristics of the words of exceptional pronunciations through phonological research and text analysis of Korean language.

### BRIEF DESCRIPTION OF DRAWINGS

This invention will be better understood and its various objects and advantages will be fully appreciated from the following descriptions taken in conjunction with the accompanying drawings, in which:

FIG. 1 shows a block diagram of an automatic pronunciation generator;

FIG. 2 indicates a method for compiling an exceptional pronunciation dictionary 1 using a general dictionary; and

FIG. 3 indicates a method for compiling a new exceptional pronunciation dictionary 2 using text corpus.

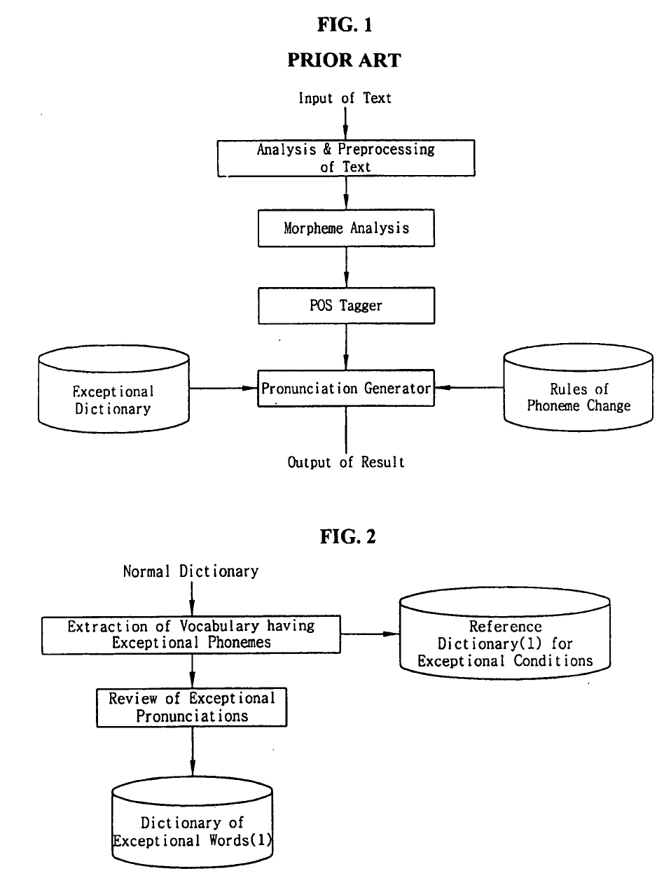

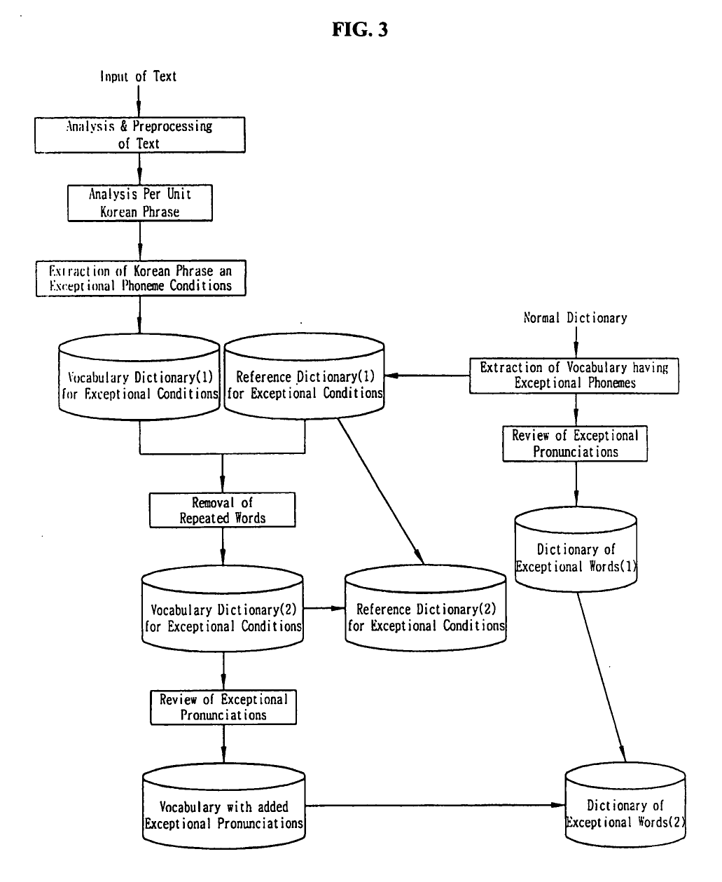

### BEST MODE FOR CARRYING OUT THE INVENTION

This invention is comprised of the steps of (1) setting exceptional sound conditions; (2) compiling an exceptional pronunciation dictionary using general dictionaries; and (3) compiling the exceptional pronunciation dictionary using text corpus.

The step of setting exceptional pronunciation conditions establishes the phoneme conditions where the exceptional pronunciations are observed based on the systematic research through the Korean phonology and the text analysis.

Although it has been thought that the phoneme conditions of exceptional pronunciations cannot be explained with any rules, the disclosed shows its regularity based on thorough researches. Accordingly, the words showing exceptional pronunciations in Korean are observed in certain limited conditions.

The step of generating the exceptional pronunciation dictionary includes the following two steps.

The first step is to generate an exceptional pronunciation dictionary by analyzing words having the exceptional pronunciations in a general Korean dictionary. By using a general Korean dictionary, the repetition of vocabulary can be minimized and also different kinds of vocabulary can be included in the exceptional pronunciation dictionary. The general Korean dictionary used as an analyzing object in this research is the YEONSEI KOREAN DICTIONARY (YKD henceforth), which has a record of about 50,000 entry words of high frequency. To generate an exceptional pronunciation dictionary, the exceptional condition reference dictionary which includes the words appearing in the exceptional pronunciation conditions needs to be established using YKD. The exceptional pronunciation dictionary is to be generated by manual review of the words listed in the exceptional condition reference dictionary.

However, vocabularies excluded in the general dictionary are also used in actual economic and social life. Furthermore, a number of vocabularies are being coined in variable conditions of life, such as the new words observed in the texts of newspapers or broadcasts, which should be extracted and listed in the exceptional pronunciation dictionary.

(1) Setting Exceptional Pronunciation Conditions

The exceptional pronunciation conditions mean phonological conditions in which the exceptional pronunciations are observed.

Accordingly, a research was preceded for systematic phonological conditions based on the characteristics of the words of exceptional pronunciations through text analysis.

The words which have exceptional pronunciations are nouns and their derivatives, which are declinable parts of speech in Korean.

In the following description, phonological conditions are disclosed where the exceptional pronunciations are observed.

Generally, phonological conditions include 4 different cases: the first case is when a vowel follows a consonant; the second, when a consonant follows a preceding consonant; the third, when a vowel follows a vowel, and the fourth is when a vowel follows a consonant.

Among the above 4 cases, the phonological conditions for the exceptional pronunciations are the second case, when a consonant follows another preceding consonant, and the fourth case, when a vowel follows a consonant. When a consonant follows another preceding consonant, the preceding consonant is a voiced sound such as [symbol] and the following consonant is a lenis sound. In this context, there are no regular phoneme rules that can be applied, but the words with lenis sound are pronounced as fortis depending on words. An example is already shown above. [symbol] and [symbol] are respectively realized as [symbol] and [symbol] In [symbol] a letter [symbol] located after a letter [symbol] is pronounced as [symbol] while in [symbol] a letter [symbol] located after a letter [symbol] is pronounced as [symbol] These words, which have different pronunciations in the same phoneme context, are exceptional pronunciation words and eventually recorded in the exceptional pronunciation dictionary.

When a vowel follows a consonant, there can be observed two cases detailed as follows. In one case, when the consonant is [symbol] is respectively pronounced as [symbol] in the same condition, for example, [symbol] and [symbol] In the other case, a letter [symbol] is inserted between the consonant and the vowel. For example, [symbol] is pronounced as

[symbol]

In this invention, the conditions of the exceptional pronunciations are arranged based on the analytical research of YKD.

The following table 1 shows the conditions in which the exceptional pronunciations are observed, and the table 2 shows examples for each condition.

TABLE 1
Exceptional pronunciation conditions

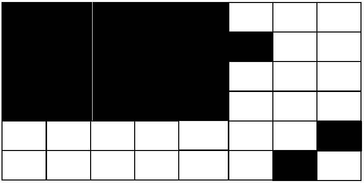

(C: Consonant, V: Vowel)

TABLE 2
Examples of exceptional pronunciations

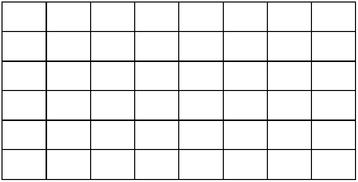

(2) Compiling an Exceptional Pronunciation Dictionary Using an General Dictionary (YKD)

A reference dictionary 1 is compiled by extracting the words (using the Table 1) in the exceptional conditions from the entries of a general dictionary which includes basic words of the Korean language.

A researcher manually reviews words of the reference dictionary 1 in the exceptional conditions and edits an exceptional pronunciation dictionary 1 by collecting words which show exceptional pronunciations.

(3) Compiling an Exceptional Pronunciation Dictionary Based on Text Corpus

The text corpus are basically an assemblage of sentences, which are to be analyzed, preprocessed, and divided into Eojols (units surrounded by space). Then the Eojols in the exceptional conditions will form the vocabulary dictionary 1 in the exceptional conditions.

Next, the vocabulary dictionary 1 in the exceptional conditions are compared with the words included in the reference dictionary 1 in the exceptional conditions generated in the previous step. As a result of the comparison, the vocabulary dictionary 2 in the exceptional condition is to be generated, after removing repeated words.

The exceptional pronunciation dictionary 2 is compiled by extracting additional words having exceptional pronunciations through manual review of the vocabulary dictionary 2 in the exceptional condition.

The new reference dictionary 2 in the exceptional conditions is created by editing the vocabulary dictionary 2 in the exceptional condition and the reference dictionary 1 in the exceptional condition. However, when an exceptional pronunciation dictionary is edited from a new text corpora, the new reference dictionary 2 for the exceptional condition will be used as the reference dictionary.

Thus, the method contributes to the performance improvement of automatic pronunciation generator in Korean as well as the performance improvement of speech recognition system and TTS system in Korean.

What is claimed is:

1. A method of generating an exceptional pronunciation dictionary for automatic pronunciation generator in Korean comprises the steps of:
setting phoneme conditions where the exceptional pronunciations are observed in Korean;
extracting words in the exceptional phoneme conditions from a general dictionary so as to compile an exceptional condition reference dictionary 1, and creating an exceptional pronunciation dictionary 1 by reviewing words of the exceptional condition reference dictionary 1 and by extracting the words having the exceptional pronunciation; and
generating the exceptional pronunciation dictionary 2 by including the steps of:
dividing sentences of text corpus by Korean Eojols after analyzing the sentences;
compiling the exceptional condition vocabulary dictionary 1 by extracting Korean Eojols, which includes the words of the exceptional condition vocabulary 1;
editing an exceptional condition vocabulary dictionary 2 by removing repeated words comparing the exceptional condition vocabulary dictionary 1 with the exceptional condition reference dictionary 1; and
reviewing the words of the exceptional condition vocabulary dictionary 2.

2. The method according to the claim 1 wherein the step of the exceptional pronunciation dictionary 2 comprises of the step of compiling the reference dictionary 2 in the exceptional conditions by adding the vocabulary dictionary 2 to the reference dictionary 1, in order to compile an exceptional pronunciation dictionary from text corpus.
